(19) United States
(12) Patent Application Publication
(10) Pub. No.: US 2001/0040701 A1
(43) Pub. Date: Nov. 15, 2001

(54) Photographic film having time resolved sensitivity distinction

(76) Inventors: Albert D. Edgar, Austin, TX (US); Douglas E. Corbin, Austin, TX (US)

Correspondence Address: SIMON, GALASSO & FRANTZ PLC., P.O. Box 26503, Austin, TX, 78755-0503, US

(21) Appl. No.: 09/774,401

(22) Filed: Jan. 30, 2001

Related U.S. Application Data
(60) Provisional application No. 60/180,014, filed on Feb. 3, 2000.

(51) Int. Cl. H04N 1/21

(52) U.S. Cl. 358/302; 358/1.9

(57) ABSTRACT

The present invention provides a photographic element comprising a transparent film support, a blue recording layer coated on the support, a green recording layer coated on the support, and a red recording layer coated on the support. The blue recording layer comprises a first image dye-forming coupler and radiation-sensitive silver halide grains for forming a developable latent image upon imagewise exposure. The green recording layer comprises a second image dye-forming coupler and radiation-sensitive silver halide grains for forming a developable latent image upon imagewise exposure. The red recording layer comprises a third image dye-forming coupler and radiation-sensitive silver halide grains for forming a developable latent image upon imagewise exposure. In addition, the radiation-sensitive silver halide grains in each recording layer comprises at least a first and second set of radiation-sensitive silver halide grains, wherein the first set of radiation-sensitive silver halide grains having a higher maximum sensitivity and a faster development time than the second set of radiation-sensitive silver halide grains.

### CROSS REFERENCE TO RELATED APPLICATIONS

This application claims the benefit of United States Provisional Patent Application Ser. No. 60/180,014 filed Feb. 3, 2000 entitled “PHOTOGRAPHIC FILM HAVING TIME RESOLVED SENSITIVITY DISTINCTION,”of common assignee herewith.

### TECHNICAL FIELD OF THE INVENTION

The present invention relates generally to the field of digital film processing and more particularly to a photographic film having time resolved sensitivity distinction.

### BACKGROUND OF THE INVENTION

In conventional color photographic development systems, the exposed film is chemically processed to produce dyes in the three layers with color densities directly proportional to the blue, green, and red spectral exposures that were recorded in the latent image. Yellow dye is produced in the top layer, magenta dye in the middle layer, and cyan dye in the bottom layer. Through a separate conventional process, positive photographic images may then be electronically scanned to produce a digital image.

Typically, color film includes multiple layers per color with different levels of sensitivity. In low light, the more-sensitive layer alone responds with large, coarse grains. In bright light, the less-sensitive layer responds with a finer-grained image. In this bright light, the coarse-grain layer would use up all of its incorporated color coupler to produce an attenuator that has less grain noise in the mid-scale and highlight exposure regions through which to view the finer grain layer.

Conventional electronic scanning of developed photographic negative film to produce digital images is done by passing visible light through the developed negative and using filters with appropriate spectral responsivities to detect, at each location on the film, the densities of the yellow, magenta and cyan dyes in the photographic negative. The density values detected in this way are indirect measures of the blue, green and red light that initially exposed each location on the film. These measured density values constitute three values used as the blue, green and red values for each corresponding location, or pixel, in the digital image. Further processing of these pixel values is often performed to produce a digital image that accurately reproduces the original scene and that is pleasing to the human eye.

In electronic film development, the film is scanned during development, thereby seeing the silver grains directly rather than the coupled dyes. The finer-grained image in the lower sensitivity layer written by brighter light would be viewed through the saturated coarse grains of the higher speed layer, thus yielding a coarse-grain scan. Accordingly, the quality and resolution of digital film processing can be enhanced by having the fine grains develop before the course grains.

### SUMMARY OF THE INVENTION

The present invention provides a photographic element comprising a transparent film support, a blue recording layer coated on the support, a green recording layer coated on the support, and a red recording layer coated on the support. The blue recording layer comprises a first image dye-forming coupler and radiation-sensitive silver halide grains for forming a developable latent image upon imagewise exposure. The green recording layer comprises a second image dye-forming coupler and radiation-sensitive silver halide grains for forming a developable latent image upon imagewise exposure. The red recording layer comprises a third image dye-forming coupler and radiation-sensitive silver halide grains for forming a developable latent image upon imagewise exposure. In addition, the radiation-sensitive silver halide grains in each recording layer comprises at least a first and second set of radiation-sensitive silver halide grains, wherein the first set of radiation-sensitive silver halide grains having a higher maximum sensitivity and a faster development time than the second set of radiation-sensitive silver halide grains.

Other features and advantages of the present invention shall be apparent to those of ordinary skill in the art upon reference to the following detailed description taken in conjunction with the accompanying drawings.

### BRIEF DESCRIPTION OF THE DRAWINGS

The above and further advantages of the invention may be better understood by referring to the following description in conjunction with the accompanying drawings in which corresponding numerals in the different figures refer to corresponding parts in which:

FIG. 1 is a perspective view of a scanning device;

FIG. 2 is an illustration of a duplex film processing system;

FIG. 3 is a schematic diagram illustrating an imaging system; and

FIG. 4 is an electronic film developer.

### DETAILED DESCRIPTION

While the making and using of various embodiments of the present invention are discussed herein in terms of a digital film processing system, it should be appreciated that the present invention provides many applicable inventive concepts which can be embodied in a wide variety of specific contexts. The specific embodiments discussed herein are merely illustrative of specific ways to make and use the invention and do not limit the scope of the invention.

The present invention provides a film or photographic element where the large grains and small grains are designed to develop at different times in the development process; as opposed to conventional film where the development of the large grains and small grains are designed to peak at the same time and have the right balance. In case of digital film development, it is desirable to have the fine grains, which bear the highlight detail, to develop quickly before the large grains have even had a chance to start growing so that the highlight detail can be captured. Thereafter, it is desirable to have the small grains stop developing and not fog anymore, so that the large grains, which represent the shadows, can start growing among them. Since the large grains are much coarser, the fine grains do not do too much damage to the image even though they are saturated.

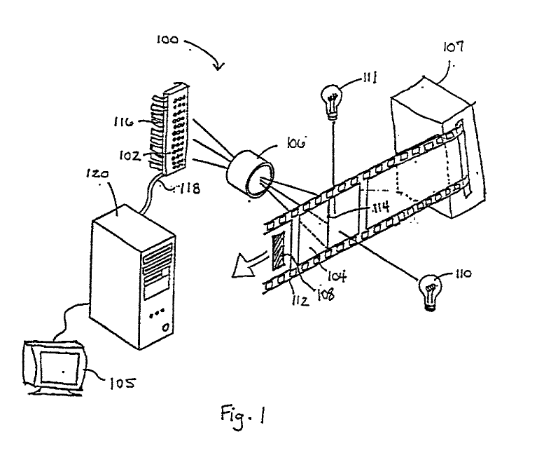

An improved imaging system 100 is shown in FIG. 1. Specifically the imaging system 100 is illustrated as a digital film processing system. The imaging system 100 operates by converting electromagnetic radiation from a scene image 104 stored on a film 112 to an electronic (digital) representation of the image. The image being scanned is embodied on a photographic media, such as film. The electromagnetic radiation used to convert the image into a digitized representation is preferably infrared light or near infrared light.

The imaging system 100 generally includes a number of optic sensors 102. The optic sensors 102 measure the intensity of electromagnetic energy passing through or reflected by the film 112. The source of electromagnetic energy is typically a light source 110 which illuminates the film 112 containing the scene image 104. Radiation from the source 110 may be diffused or directed by additional optics such as filters (not shown) and one or more lenses 106 positioned near the sensors 102 and the film 114 in order to illuminate the image 104 more uniformly. Furthermore, more than one source may be used.

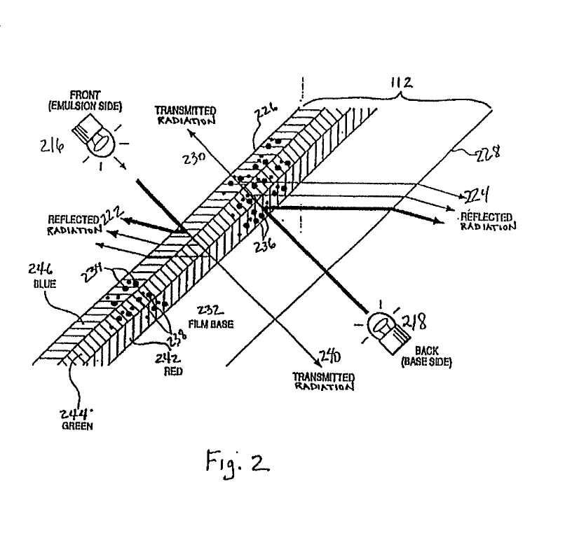

Source 110 is positioned on the side of the film 112 opposite the optic sensors 102. This placement results in sensors 102 detecting radiation emitted from source 110 as it passes through the images 104 and 108 on the film 112. Another radiation source 111 is shown placed on the same side of the film 112 as the sensors 102. When source 111 is activated, sensors 102 detect radiation reflected by the images 104 and 108. This process of using two sources positioned on opposite sides of the film 112 is described in more detail below in conjunction with FIG. 2.

The optic sensors 102 are generally geometrically positioned in arrays such that the electromagnetic energy striking each optical sensor 102 corresponds to a distinct location 114 in the image 104. Accordingly, each distinct location 114 in the scene image 104 corresponds to a distinct location, referred to as a picture element, or “pixel” for short, in the scanned, or digitized image 105. The image 104 on film 112 are usually sequentially moved, or scanned, across the optical sensor array 102. The optical sensors 102 are typically housed in a circuit package 116 that is electrically connected, such as by cable 118, to supporting electronics for computer data storage and processing, shown together as computer 120. Computer 120 may then process the digitized image 105. Alternatively, computer 120 may be replaced with a microprocessor and cable 118 replaced with an electrical circuit connection.

Optical sensors 102 may be manufactured from different materials and by different processes to detect electromagnetic radiation in varying parts and bandwidths of the electromagnetic spectrum. The optical sensor 102 includes a photodetector (not expressly shown) that produces an electrical signal proportional to the intensity of electromagnetic energy striking the photodetector. Accordingly, the photodetector measures the intensity of electromagnetic radiation attenuated by the image 104 on film 112.

Turning now to FIG. 2, a conventional color film 112 is depicted. Duplex film scanning refers to using a front source 216 and a back source 218 to scan a film 112 with reflected radiation 222 from the front 226 and reflected radiation 224 from the back 228 of the film 112 and by transmitted radiation 230 and 240 that passes through all layers of the film 112. The sources 216, 218 are generally monochromatic and preferable infrared. The respective scans, referred to herein as front, back, front-through and back-through, are further described below.

In FIG. 2, separate color levels are viewable within the film 112 during development of the red layer 242, green layer 244 and blue layer 246. Over a clear film bases 232 are three layers 242, 244, 246 sensitive separately to red, green and blue light, respectively. These layers are not physically the colors but rather, they are sensitive to these colors. In conventional color film development, the blue sensitive layer 246 would eventually develop a yellow dye, the green sensitive layer 244 a magenta dye, and the red sensitive layer 242 a cyan dye.

During development, layers 242, 244, and 246 are opalescent. Dark silver grains 234 developing in the top layer 246, the blue source layer, are visible from the front 226 of the film, and slightly visible from the back 228 because of the bulk of the opalescent emulsion. Similarly, grains 236 in the bottom layer 242, the red sensitive layer, are visible from the back 228 by reflected radiation 224, but are much less visible from the front 226. Grains 238 in the middle layer 244, the green sensitive layer, are only slightly visible to reflected radiation 222, 224 from the front 226 or the back 228. However, they are visible along with those in the other layers by transmitted radiation 230 and 240. By sensing radiation reflected from the front 226 and the back 228 as well as radiation transmitted through the film 112 from both the front 226 and back 228 of the film, each pixel for the film 112 yields four measured values, one from each scan, that may be mathematically processed in a variety of ways to produce the initial three colors, red, green and blue, closest to the original scene.

The front signal records the radiation 222 reflected from the illumination source 216 in front of the film 112. The set of front signals for an image is called the front channel. The front channel principally, but not entirely, records the attenuation in the radiation from the source 216 due to the silver metal particles 234 in the top-most layer 246, which is the blue recording layer. There is also some attenuation of the front channel due to silver metal particles 236, 238 in the red and green layers 242, 244.

The back signal records the radiation 224 reflected from the illumination source 218 in back of the film 112. The set of back signals for an image is called the back channel. The back channel principally, but not entirely, records the attenuation in the radiation from the source 218 due to the silver metal particles 236 in the bottom-most layer 242, which is the red recording layer. Additionally, there is some attenuation of the back channel due to silver metal particles 234, 238 in the blue and green layers 246, 244.

The front-through signal records the radiation 230 that is transmitted through the film 220 from the illumination source 218 in back of the film 112. The set of front-through signals for an image is called the front-through channel. Likewise, the back-through signal records the radiation 240 that is transmitted through the film 112 from the source 216 in front of the film 112. The set of back-through signals for an image is called the back-through channel. Both through channels record essentially the same image information since they both record the attenuation of the radiation 230, 240 due to the silver metal particles 234, 236, 238 in all three red, green, and blue recording layers 242, 244, 246 of the film 112.

Several image processing steps are required to convert the illumination source radiation information for each channel to the red, green, and blue. These steps are required because the silver metal particles 234, 236, 238 that form during the development process are not spectrally unique in each of the film layers 242, 244, 246. These image processing steps are not performed when conventional scanners are used because the dyes which are formed with conventional chemical color processing scanners, once initial red, green and blue values are derived for each image, further processing of the red, green and blue values is usually done to produce images that more accurately reproduce the original scene and that are pleasing to the human eye.

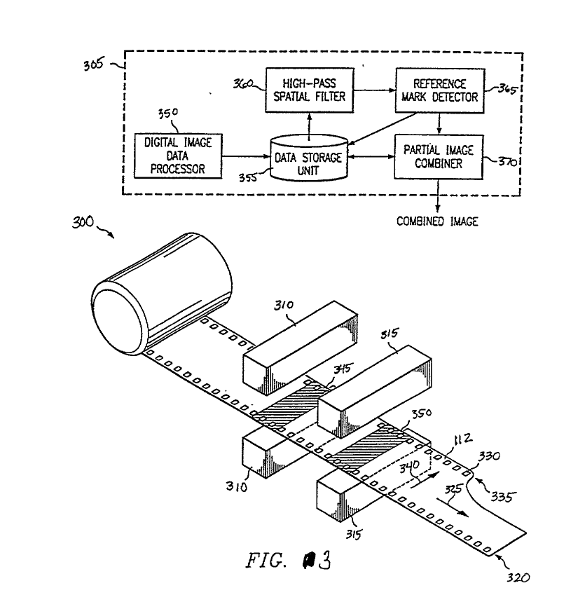

FIG. 3 is a schematic illustration of several elements of the data processor 305. FIG. 3 also illustrates, schematically, some components interior to the electronic film developer 300. The electronic film developer 300 is in communication with the data processor 300. The electronic film developer 300 has one or more image scanning stations 310 and 315. Although the example of the digital image scanner 300 illustrated in FIG. 3 is a schematic illustration of an electronic film developer having two scanning stations, it is anticipated that other electronic film developers will preferably have three scanning stations. Furthermore, it is anticipated that other electronic film developers may have a single scanning station.

In the preferred embodiment, exposed photographic film 112 is directed to move through the scanning stations in the longitudinal direction 325 known as the “scan direction.” The photographic film 320 has reference markers 320 at one transverse edge of the photographic film 320. In this embodiment, the reference markers 320 are sprocket holes, such as sprocket hole 330, in the photographic film 112. The photographic film 112 has additional reference markers 335 in the transverse direction 340 opposing the reference markers 320. Scanning stations for electronic film development are also described in U.S. Pat. No. 5,519,510 and U.S. Pat. No. 5,155,596 which are incorporated herein in their entirety.

In electronic film development, the photographic film 112 is typically subjected to film development treatment prior to entering the scanning stations. If multiple scanning stations are used, the film will be at one stage of development at the first scanning station and at another stage of film development at the second scanning station, and so on.

Scanned image data is transferred from each scanning station 310 and 315 to the data processor 305. The data processor 305 has a digital image data processor 350 that is in communication with the scanning stations 310 and 315. The digital image data processor 350 is also in communication with a data storage unit 355 that stores processed image data. The data storage unit 355 is in communication with a high-pass spatial filter 360 such that it receives stored raster image data from the storage unit 355. A reference mark detector 365 is in communication with a high-pass spatial filter 360 such that it receives filtered images from the high-pass spatial filter 360. The reference mark detector 365 is also in communication with the data storage unit 355. The partial image combiner 370 is in communication with the reference mark detector 365 and the data storage unit 355. In the preferred embodiment, the digital image data processor 350, the high-pass spatial filter 360, the reference mark detector 365 and the partial image combiner 370 are implemented in practice by programming a personal computer or a workstation. However, the invention includes other embodiments in which the components are implemented as dedicated hardware components.

Preferably, the digital image data processor 350 processes scanned data from scanning stations 310 and 315 and outputs a digital raster image in a conventional format to be stored in data storage unit 355. In the preferred embodiment, the data storage unit 355 may be either a conventional hard drive or semiconductor memory, such as random access memory (RAM), or a combination of both. It is anticipated that other data storage devices may be used without departing from the scope and spirit of the invention. In one embodiment, the high-pass spatial filter uses a conventional spatial mask such as that described in R. C. Gonzales and R. E. Woods, Digital Image Processing, pages 189-249, the entire contents of which is incorporated herein by reference. In such a high-pass spatial filter, a three-pixel-by-three-pixel mask is usually sufficient, although one may select larger masks. For a three-pixel-by-three-pixel mask, the center mask element is given a weight with a value of 8 and each neighbor pixel is given a weight of 1. The mask is then applied to each pixel of the raster image. If the subject pixel is in a fairly uniform region of the image, the sum of all the neighboring pixel values multiplied by the mask value will cancel with the central value, thus leading to essentially a zero output value. However, in the region of an edge of the image, the output will be non-zero. Consequently, such a filter will provide an output image which represents the edges of the original image. These are thus referred to as edge images.

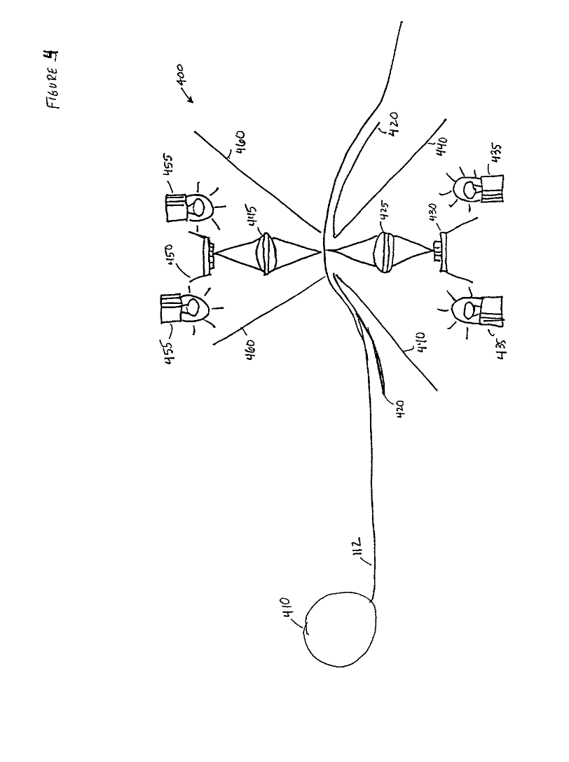

Referring to FIG. 4, an electronic film developer is generally depicted as 400. A roll of film 410 is fed through the electronic film developer 400. The film 112 is guided in a longitudinal manner until the film 112 reaches a film bridge 420. The film bridge guides the film between a front image sensor 450 and a back image sensor 430. The front image sensor 450 and the back image sensor 430 comprise an image sensing station. The film bridge 420 has a slot formed at its apex to allow light to be transmitted to the film 112 through the film bridge 420. The image sensing station may also include a back lens 425, and a front lens 445, as well as wave guides 440 and 460. The back lens 425 and the front lens 445 assist in focusing onto the front image sensor and the back image sensor images captured from the film. Back lighting elements 435 and front lighting elements 455 illuminate the film 112 as it passes over the film bridge.

The back image sensor 430 and the front image sensor 450 are aligned in parallel as shown in FIG. 5. The front image sensor 505 and the back image sensor 510 include several optical sensors. The front optical sensors are depicted as 530, 535, 540, 545. The back optical sensors are depicted as 550,555, 560, 565. The film 112 has a front surface 520 and a back surface 525. As shown, the optical sensors from the imaging sensor 505 and the optical sensors from the back image sensor 510 are aligned in parallel. For example, imaging element 535 and imaging element 555 can capture images or signals from the same pixel within the film 112. Although the optical sensors are shown as large squares in FIG. 5, each imaging element represents a single pixel within an image on the film.

The photographic film having time resolved sensitivity distinction in accordance with the present invention will be described below. Camera speed films typically employ high bromide silver halide emulsions. Separate images of each of blue, green and red exposures are captured in blue, green and red recording layers within the film. The blue recording layer contains chemically sensitized high bromide grains that may rely on native blue sensitivity or be sensitized to the blue region of the spectrum with one or more blue absorbing spectral sensitizing dyes. The green recording layer contains chemically sensitized high bromide grains that are sensitized to the green region of the spectrum with one or more green absorbing spectral sensitizing dyes. The red recording layer contains chemically sensitized high bromide grains that are sensitized to the red region of the spectrum with one or more red absorbing spectral sensitizing dyes. Dye-forming couplers, which are a dye forming chemical, are typically included in the layers to allow dye images of distinguishable hue to be formed upon color processing. When the photographic film is intended for reversal processing to produce a viewable color positive image or when the photographic film is intended for use in exposing a color paper, the blue, green and red recording layers contain couplers that form blue absorbing (yellow), green absorbing (magenta), and red absorbing (cyan) image dyes, respectively. When the dye image information is intended to be retrieved from the photographic film by digital scanning, the dye images can be of any hue, provided they are distinguishable.

The components used to construct color photographic films are disclosed in Research Disclosure, Vol. 389, September 1996, Item 38957. Research Disclosure is published by Kenneth Mason Publications, Ltd., Dudley House, 12 North St., Emsworth, Hampshire P010 7DQ, England. The following topics of Item 38957 are particularly pertinent to the present invention:

I. Emulsion grains and their preparation;

II. Vehicles, vehicle extenders, vehicle-like addenda and vehicle related addenda;

IV. Chemical sensitization;

V. Spectral sensitization and desensitization;

VII. Absorbing and scattering materials;

X. Dye image formers and modifiers;

XI. Layers and layer arrangements;

XII. Features applicable only to color negative;

XIII. Features applicable only to color positive;

XV. Supports.

A simple construction of a color photographic element satisfying the requirements of the invention is illustrated by the following:

Protective Overcoat

Blue Recording Layer

Green Recording Layer

Red Recording Layer

Antihalation Layer

Transparent Film Support

Each of the blue, green and red recording layers incorporate high bromide silver halide grains for latent image formation upon imagewise exposure. The high bromide grains preferably each contain greater than 70 mole percent bromide and optimally greater than 90 mole percent bromide, based on total silver. The grains can form latent image sites at the surface of the grains, internally or at both locations, but preferably form latent image sites primarily at the surface of the grains. The portion of the silver halide not accounted for by silver bromide can be any convenient conventional concentration of silver iodide and/or chloride. Silver iodide can be present up to its solubility limit in silver bromide, typically cited as 40 mole percent, based on total silver. However, iodide concentrations of less than 20 mole percent are preferred and iodide concentrations of less than 10 mole percent, based on total silver, are most preferred. Silver chloride concentrations are preferably limited to less than 30 mole percent and optimally less than 10 mole percent, based on total silver. Silver iodobromide grain compositions are specifically preferred. Other contemplated grain compositions include silver bromide, silver chlorobromide, silver iodochlorobromide and silver chloroiodobromide. The latent image forming silver halide grains can take the form of those disclosed in Research Disclosure, Item 38957, cited above, 1. Emulsion grains and their preparation.

The latent image forming high bromide emulsions are chemically sensitized. Any of the chemical sensitizations of Research Disclosure, Item 38957, IV. Chemical sensitization. One or a combination of sulfur, selenium and gold sensitizations are commonly employed. Additionally, the epitaxial sensitization of the grains is contemplated.

In all instances the latent image forming grains in the minus blue recording layers are spectrally sensitized. The green recording layer contains one or a combination of green absorbing spectral sensitizing dyes adsorbed to the surfaces of the latent image forming grains. The red recording layer contains one or a combination of red absorbing spectral sensitizing dyes adsorbed to the surfaces of the latent image forming grains. The latent image forming grains of the blue recording layer can rely entirely on native blue absorption, particularly when the grains contain iodide. Preferably the blue recording layer contains one or a combination of blue absorbing spectral sensitizing dyes adsorbed to the surfaces of the latent image forming grains. Spectral sensitizing dyes and dye combinations can take the forms disclosed in Research Disclosure, Item 38957, V. Spectral sensitization and desensitization, A. sensitizing dyes.

In addition to silver halide grains the dye image forming layers contain dye image-forming couplers to produce image dyes following imagewise exposure and color processing. When the photographic elements are intended to be used for exposing a color paper or to form viewable reversal color images, the blue, green and red recording layers contain dye-forming couplers that form on coupling yellow, magenta and cyan image dyes, respectively. When the photographic elements are intended to be scanned, an image dye of any convenient hue can be formed in any of the blue, green and red recording layers, provided that the image dyes can be differentiated by inspection or scanning. To facilitate scanning each image dye is contemplated to exhibit a half peak absorption bandwidth of at least 25 nm, preferably 50 nm, that does not overlap the half peak absorption bandwidth of any image dye in another recording layer. Dye image-forming couplers can take any of the various forms disclosed in Research Disclosure, Item 38957, X. Dye image formers and modifiers, B. Image-dye-forming couplers.

Each recording layer may comprise a single hydrophilic colloid layer comprising both fast latent image forming radiation-sensitive silver halide grains and slow latent image forming radiation-sensitive silver halide grains. A single radiation-sensitive silver halide layer reduces cost since every layer the manufacture puts on a film adds to the cost of the film. Moreover, a single thick layer can be applied more accurately than multiple thin layers.

Alternatively, each recording layer may be divided into at least two hydrophilic colloid layers:

Fast Latent Image Forming Layer

Slow Latent Image Forming Layer

The fast latent image forming hydrophilic colloid layer is positioned over the slow latent image forming hydrophilic colloid layer to receive exposing red light prior to the slow layer. Red recording layer latent image forming silver halide grains of maximum sensitivity are located in the fast layer. The slow latent image forming layer is preferably at least one stop (0.3 log E) slower than the fast latent image forming layer, with the speed difference between the two layers commonly ranging up to three stops (0.9 log E).

The function of the fast layer is to increase image dye density at exposure levels lower than the lowest exposure levels that produce image dye in the slow layer. Once exposures reach a level that allow image dye to be generated in the slow emulsion layer, additional image dye formation at higher exposures preferably occurs in the slow layer, since this minimizes image granularity. Thus, the fast layer can contain as little as 2 percent (preferably at least 5 percent), based on silver, of the latent image forming silver halide grains. The proportion of latent image forming silver halide grains present in the fast layer can range up to 50 percent, based on silver, but is typically less than 20 percent.

Similarly, each recording layer may comprise a fastest latent image forming layer, a mid latent image forming layer and a slowest latent image forming layer as follows:

Fastest Latent Image Forming Layer

Mid Latent Image Forming Layer

Slowest Latent Image Forming Layer

The recording layer can be constructed similarly as described above, but with the modification that latent image forming grains in the mid (speed) and slowest latent image forming layers can be obtained by segregating the latent image forming silver halide grains in the slow latent image forming layer of into two separate layers. The slowest layer is preferably at least 0.3 log E (typically 0.3 to 0.9 log E) slower than the mid latent image forming layer, while the mid latent image forming layer retains the same speed separation from the fastest latent image forming layer.

The present invention retards coarse grains in development relative to fine grains. In a region exposed to brighter light, the fine grains develop first, allowing an early scan to see the finer-grained image free from masking by coarser grains. In dimmer light, the coarse grains develop slowly, allowing a late scan to see these more sensitive grains. Because finer grains remain undeveloped in dimmer light, they do not affect the scan.

An effective way to retard the development of coarse grains is to alter their surface silver halide composition with an increased amount of a less-soluble halide by converting the AgCl on the surface of the filming AgClBr, i.e., by halide conversion. Halide conversion can also be accomplished by converting AgBrl that has 3% to AgBrl that has 6% I.

The present invention could employ many other methods to retard the development of coarse grains. The emulsion could be designed with developer retarders. It could coat the emulsion on the film with development retarders (typically antifoggants) in some layers, using any of the following techniques: standard, encapsulated, ballasted in oil droplets, ballasted by large hydrophobic groups, releasable (as DIRs, DLARs, etc.) ballasted to dye-forming or developer-agent or non-dye-forming couplers, and solubilized (to diffuse away).

Coarse grains can also be retarded by absorbing development retarders as emulsion addenda, using any of the following techniques:

standard antifoggants (activity range from benzotriazole to phenylmercaptotetrazole);

antifoggants with solubilizing groups, which can diffuse away and thus diminish in activity over time;

spectral-sensitizing dyes chosen for development retardation;

spectral-sensitizing dyes with added solubility function groups, which can diffuse away with time;

standard emulsion stabilizers;

emulsion stabilizers with solubilizing groups; and

other surface-absorptive emulsion addenda.

In addition coarse grains can be retarded by

reducing the level of chemical sensitization (to lower sulfur plus gold levels, for example);

altering the type of chemical sensitization, using S only and no Au for example;

removal of reduction sensitization, for example by oxidation (bromination);

not using development accelerators in the same layer as large grains;

encapsulating large grains;

designing the emulsion with developer inhibiting/releasing agents, either standard or ballasted; and

using developing agents in the developer that are capable of releasing development inhibitors upon development.

An alternate approach is to accelerate the development of fine grains relative to slowly developing large grains by using in accelerators (quaternary ammonium salts, etc.) instead of the development retarders mentioned above.

If you change the composition of the grains from the white or silver chlorides to the heavier ones, such as silver iodite, they become more and more insoluble and more difficult to develop. So one technique to slow development is to increase the proportion of silver iodide. Typically camera speed sensitive grains are some ratio of silver bromite and iodide. Alternatively, the chemical sensitization, which is the chemical process that the precipitated emulsion is put through after its made, can be changed. Sodium sulfate and/or chemicals like flurochloric acid which deposit small amounts of gold on the crystal and are put on there primarily for increase in sensitivity can also effect the development rate. So, the amounts in the chemical treatment time can be modified to produce a slower development. If fact, both higher speed and slower development may be achieved. The chemical ratio can also be used to control speed of development. Spectral sensitizing dyes, which are put on the grains to confer color sensitivity, can effect development rate because they typically interfere with the development rate. Similarly, anti-fog elements can be added to the developer. These anti-fog elements are organic compounds that tend to form insoluble silver salts with the silver halides and are actually more insoluble then the silver halide itself. Emulsion stabilizers can also be used because they tend to be put in there to preserve the light and image over time and prevent fog buildup. But they can be selected to be very strongly absorbed through the crystal so that they slow down development. The grains can also be encapsulated, which is a coating around the grain that would presumably control diffusion of the developer and then slow it down.

The remaining features of the color photographic element can take any convenient conventional form. In addition to the silver halide grains and image dye-forming coupler, the blue, green and red recording layers as well as all other processing solution permeable layers of the color photographic elements, such as the protective overcoat and the antihalation layer, contain processing solution permeable vehicle, typically hydrophilic colloid, such as gelatin or a gelatin derivative, as well as vehicle extenders and hardener, examples of which are listed in Research Disclosure, Item 38957, II. Vehicles, vehicle extenders, vehicle-like addenda and vehicle related addenda. The layers containing latent image forming silver halide grains additionally usually contain antifoggants and/or stabilizers, such as those listed Research Disclosure, Item 38957, VII. Antifoggants and stabilizers. The dye image forming layers can contain in addition to the dye image-forming couplers other dye image enhancing addenda, such as image dye modifiers, hue modifiers and/or stabilizers, and solvents for dispersing couplers and related hydrophobic addenda, summarized in X. Dye image formers and modifiers, sections C, D and E. Colored dye-forming couplers, such as masking couplers, are commonly incorporated in negative-working photographic films, as illustrated in Research Disclosure, Item 38957, XII. Features applicable only to color negative.

The antihalation layer is not essential, but is highly preferred to improve image sharpness. The antihalation layer can be coated between the red recording layer and the transparent film support or, alternatively, coated on the back side of the transparent film support. In addition to vehicle to facilitate coating the antihalation layer contains light absorbing materials, typically dyes, chosen to be decolorized (discharged) on processing, a summary of which is provided in Research Disclosure, Item 38957, VIII. Absorbing and scattering materials, B. Absorbing materials and C. Discharge.

The protective overcoat is not essential, but is highly preferred to provide physical protection to the blue recording layer. In its simplest form the protective overcoat can consist of a single layer containing a hydrophilic vehicle of the type described above. The protective overcoat is a convenient location for including coating aids, plasticizers and lubricants, antistats and matting agents, a summary of which is provided in Research Disclosure, Item 38957, IX. Coating and physical property modifying addenda. Additionally, ultraviolet absorbers are often located in the protective overcoat, illustrated in Research Disclosure, Item 38957, UV dyes/optical brighteners/luminescent dyes. Often the protective overcoat is divided into two layers with the above addenda being distributed between these layers. It is also common practice to place a layer similar to the protective overcoat in the back side of the support containing surface property modifying addenda. When an antihalation layer is coated on the back side of the support, surface modifying addenda are usually incorporated in this layer.

To avoid color contamination of the blue, green and red recording layers, it is conventional practice to incorporate a oxidized developing agent scavenger (a.k.a. antistain agent) in the layers to prevent migration of oxidized color developing agent from one layer to the next adjacent layer. Preferably the oxidized color developing agent is located in a separate layer, not shown in (I) above, at the interface of the layers. Antistain agents are summarized in Research Disclosure, Item 38957, D. Hue modifiers/stabilization, paragraph (2).

It is also preferred to locate a blue filter material, such as a processing solution decolorizable yellow dye or Carey Lea silver, in a layer between the latent image forming grains in the blue recording layer and the next adjacent layer. These filter materials are also disclosed in Research Disclosure, Item 38957, VIII. Absorbing and scattering materials, B. Absorbing materials and C. Discharge.

The transparent film support can take any convenient conventional form. The film support is generally understood to include subbing layers placed on the film to improve the adhesion of hydrophilic colloid layers. Conventional transparent film support characteristics are summarized in Research Disclosure, Item 38957, XV. Supports (2), (3), (4), (7), (8) and (9).

It is intended that the description of the present invention provided above is but one embodiment for implementing the invention. Variations in the description likely to be conceived of by those skilled in the art still fall within the breadth and scope of the disclosure of the present invention. While specific alternatives to steps of the invention have been described herein, additional alternatives not specifically disclosed but known in the art are intended to fall within the scope of the invention. Thus, it is understood that other applications of the present invention will be apparent to those skilled in the art upon the reading of the described embodiment and a consideration of the appended claims and drawings.

What is claimed is:

1. A photographic element comprising:
a transparent film support;
a blue recording layer coated on the support, the blue recording layer comprising a first image dye-forming coupler and radiation-sensitive silver halide grains for forming a developable latent image upon imagewise exposure;
a green recording layer coated on the support, the green recording layer comprising a second image dye-forming coupler and radiation-sensitive silver halide grains for forming a developable latent image upon imagewise exposure;
a red recording layer coated on the support, the red recording layer comprising a third image dye-forming coupler and radiation-sensitive silver halide grains for forming a developable latent image upon imagewise exposure; and
wherein the radiation-sensitive silver halide grains in each recording layer comprises at least a first and second set of radiation-sensitive silver halide grains, the first set of radiation-sensitive silver halide grains having a higher maximum sensitivity and a faster development time than the second set of radiation-sensitive silver halide grains.

2. The photographic element as recited in claim 1 wherein the first image dye-forming coupler forms a yellow image dye, the second image dye-forming coupler forms a magenta image dye, and the third image dye-forming coupler forms a cyan image dye.

3. The photographic element as recited in claim 1 wherein the first and second sets of radiation-sensitive silver halide grains are disposed within a single emulsion layer.

4. The photographic element as recited in claim 1 wherein the first set of radiation-sensitive silver halide grains are disposed within a first emulsion layer and the second set of radiation-sensitive silver halide grains are disposed within a second emulsion layer.

5. The photographic element as recited in claim 1 wherein the radiation-sensitive silver halide grains further comprises a third set of radiation-sensitive silver halide grains having a maximum sensitivity and a development time between that of the first set of radiation-sensitive silver halide grains and the second set of radiation-sensitive silver halide grains.

6. The photographic element as recited in claim 1 wherein the development time of the second set of radiation-sensitive silver halide grains is retarded by increasing the amount of less-soluble halide within the composition of the second set of radiation-sensitive silver halide grains.

7. The photographic element as recited in claim 1 wherein the development time of the second set of radiation-sensitive silver halide grains is retarded by using a development retarder as an emulsion addenda.

8. The photographic element as recited in claim 1 wherein the development time of the second set of radiation-sensitive silver halide grains is retarded by using an antifoggant.

9. The photographic element as recited in claim 1 wherein the development time of the second set of radiation-sensitive silver halide grains is retarded by using an antifoggant with solubilizing groups which diffuse away and diminish in activity over time.

10. The photographic element as recited in claim 1 wherein the development time of the second set of radiation-sensitive silver halide grains is retarded by using a development retarding spectral-sensitizing dye.

11. The photographic element as recited in claim 1 wherein the development time of the second set of radiation-sensitive silver halide grains is retarded by using a development retarding spectral-sensitizing dye with added solubility function groups which diffuse away with time.

12. The photographic element as recited in claim 1 wherein the development time of the second set of radiation-sensitive silver halide grains is retarded by using an emulsion stabilizer.

13. The photographic element as recited in claim 1 wherein the development time of the second set of radiation-sensitive silver halide grains is retarded by using an emulsion stabilizer with solubilizing groups.

14. The photographic element as recited in claim 1 wherein the development time of the second set of radiation-sensitive silver halide grains is retarded by reducing the level of chemical sensitization.

15. The photographic element as recited in claim 1 wherein the development time of the second set of radiation-sensitive silver halide grains is retarded by altering the type of chemical sensitization.

16. The photographic element as recited in claim 1 wherein the development time of the second set of radiation-sensitive silver halide grains is retarded by removal of reduction sensitization.

17. The photographic element as recited in claim 1 wherein the development time of the second set of radiation-sensitive silver halide grains is retarded by encapsulating the second set of radiation-sensitive silver halide grains.

18. The photographic element as recited in claim 1 wherein the development time of the second set of radiation-sensitive silver halide grains is retarded by including developer inhibiting/releasing agents within the emulsion.

19. The photographic element as recited in claim 1 wherein the development time of the first set of radiation-sensitive silver halide grains is accelerated by using accelerators.
